(19) United States
(12) Patent Application Publication
(10) Pub. No.: US 2026/0204279 A1
(43) Pub. Date: Jul. 16, 2026

(54) METHOD, APPARATUS, DEVICE AND STORAGE MEDIUM FOR DETERMINING A NOISE LEVEL

(71) Applicant: Beijing Zitiao Network Technology Co., Ltd., Beijing (CN)

(72) Inventors: Chang XIAO, Beijing (CN); Jiamin ZHANG, Beijing (CN); Manjia CHEN, Beijing (CN); Weisi WANG, Beijing (CN)

(21) Appl. No.: 19/438,330

(22) Filed: Dec. 31, 2025

(30) Foreign Application Priority Data
Jan. 15, 2025 (CN) 202510065908.9

(51) Int. Cl. G10L 25/84; G10L 25/18; G10L 25/21

(52) U.S. Cl. CPC G10L 25/84; G10L 25/18; G10L 25/21

(57) ABSTRACT

Embodiment of the disclosure relates to a method, apparatus, device and storage medium for determining a noise level. The method includes: determining, for each of a plurality of audio segments, feature values that each corresponds to a respective one of a plurality of predetermined audio features based on spectrum information and energy spectrum information corresponding to the plurality of audio segments in an audio; determining whether each of the plurality of audio segments is a speech segment based on whether feature values satisfy a first feature requirement related to speech; determining whether each of the plurality of audio segments is a noise segment comprising a predetermined noise based on whether feature values satisfy a second feature requirement related to the predetermined noise; and determining a noise level of the audio based on an audio segment other than the speech segment and the noise segment among the plurality of audio segments.

### CROSS-REFERENCE TO RELATED APPLICATION

This application claims the benefit of Chinese Patent Application No. 202510065908.9, filed on Jan. 15, 2025, entitled “METHOD, APPARATUS, DEVICE AND STORAGE MEDIUM FOR DETERMINING A NOISE LEVEL,” the entire content of which is incorporated herein by reference.

### FIELD

Example embodiments of the present disclosure generally relate to the technical field of computers, and more particularly, to a method, apparatus, device and storage medium for determining a noise level.

### BACKGROUND

With the increasing complexity of modern living and working environments, noise issues have become more prominent. To improve this situation, some devices can adjust the volume of the device based on environmental noise, thereby providing a more comfortable auditory experience. Specifically, these devices can use sensors such as microphones to collect ambient sounds and recognize noise within the ambient sounds. Subsequently, these devices can further adjust the volume of the device based on the noise recognition results, ensuring that the user can clearly hear the sounds played by the device.

### SUMMARY

In a first aspect of the present disclosure, a method for determining a noise level is provided. The method includes: determining, for each of a plurality of audio segments, feature values that each corresponds to a respective one of a plurality of predetermined audio features based on spectrum information and energy spectrum information corresponding to the plurality of audio segments in an audio; determining whether each of the plurality of audio segments is a speech segment based on whether feature values satisfy a first feature requirement related to speech; determining whether each of the plurality of audio segments is a noise segment including a predetermined noise based on whether feature values satisfy a second feature requirement related to the predetermined noise; and determining a noise level of the audio based on an audio segment other than the speech segment and the noise segment among the plurality of audio segments.

In a second aspect of the present disclosure, an apparatus for determining a noise level is provided. The apparatus includes: a feature value determining module configured to determine, for each of a plurality of audio segments, feature values that each corresponds to a respective one of a plurality of predetermined audio features based on spectrum information and energy spectrum information corresponding to the plurality of audio segments in an audio; a speech segment determining module configured to determine whether each of the plurality of audio segments is a speech segment based on whether the feature values satisfy a first feature requirement related to speech; a noise segment determining module configured to determine whether each of the plurality of audio segments is a noise segment including a predetermined noise based on whether feature values satisfy a second feature requirement related to the predetermined noise; and a noise level determining module configured to determine a noise level of the audio based on an audio segment other than the speech segment and the noise segment among the plurality of audio segments.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer readable storage medium has computer-executable instructions stored thereon, the computer-executable instructions being executable by a processor to implement the method of the first aspect.

In a fifth aspect of the present disclosure, a computer program product is provided. The computer program product includes computer-executable instructions, where the computer-executable instructions, when executed by a processor, implement the method of the first aspect of the present disclosure.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIG. 2 illustrates a flowchart of a process for determining a noise level according to some embodiments of the present disclosure;

FIG. 3 illustrates a flowchart of an overall process for determining a noise level according to some embodiments of the present disclosure;

FIG. 4 illustrates a flowchart of a process for recognizing a speech segment and a noise segment according to some embodiments of the present disclosure;

FIG. 5 illustrates a schematic structural block diagram of an apparatus for determining a noise level according to some embodiments of the present disclosure; and

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the term “including” and the like should be understood to include “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

The embodiments of the present disclosure may involve data of the user, obtaining and/or using the data, and the like. These aspects all follow the corresponding laws and regulations and related regulations. In the embodiments of the present disclosure, all data is collected, obtained, processed, handled, forwarded, used, etc., all of which are performed on the premise the knowledge and confirmation of the user. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As briefly described above, current devices may adjust the playback volume of the device according to environment noise, thereby providing a more comfortable auditory experience. However, the accuracy of such devices during noise estimation is relatively low, resulting in unnecessary adjustments to playback volume in some non-essential situations. Specifically, when wind noise or user speech is present in the environment, the device may incorrectly determine that the environment noise is excessive and unnecessarily adjust the playback volume, as the device cannot effectively distinguish between these two scenarios. In reality, wind noise or human speech has little impact on the audio played by the listening device. Such unnecessary adjustments not only interfere with the user's normal auditory experience (for example, the device may increase the playback volume when users are speaking nearby), but also lead to increased energy consumption of the device.

In this regards, embodiments of the present disclosure provides a solution for determining noise level. According to the solution, for each of a plurality of audio segments, feature values that each corresponds to a respective one of a plurality of predetermined audio features are determined based on spectrum information and energy spectrum information corresponding to the plurality of audio segments in an audio. Whether each of the plurality of audio segments is a speech segment is determined based on whether feature values satisfy a first feature requirement related to speech. In addition, whether each of the plurality of audio segments is a noise segment including a predetermined noise is determined based on whether feature values satisfy a second feature requirement related to the predetermined noise. A noise level of the audio is determined based on an audio segment other than the speech segment and the noise segment among the plurality of audio segments.

As will be more clearly understood from the following description, the solution of the present disclosure first determines, for each of a plurality of audio segments, feature values that each corresponds to a respective one of a plurality of predetermined audio features based on spectrum information and energy spectrum information of each audio segment. Such feature values can provide an effective data basis for subsequent speech and predetermined noise recognition. Next, the solution of the present disclosure utilizes these feature values to determine whether each audio segment is a speech segment (e.g., an audio segment including user speech) or a noise segment including a predetermined noise (e.g., an audio segment including wind noise). In the process of determining a noise level of an audio, the solution of the present disclosure removes a speech segment in the plurality of audio segments and a noise segment including a predetermined noise, and evaluates the noise level of the audio (e.g., ambient sound collected by the device) based on the remaining audio segments. In this way, the present disclosure eliminates the influence of audio segments that have little impact on the auditory experience of the user on noise estimation, thereby more accurately estimating the true noise level of the audio. In this way, the solution of the present disclosure avoids the problem that existing devices incorrectly adjust volume due to inaccurate noise estimation, thereby improving the accuracy and reasonableness of volume adjustment and enhancing the auditory experience of the user.

Various example implementations of this scheme will be described in detail below in conjunction with the accompanying drawings.

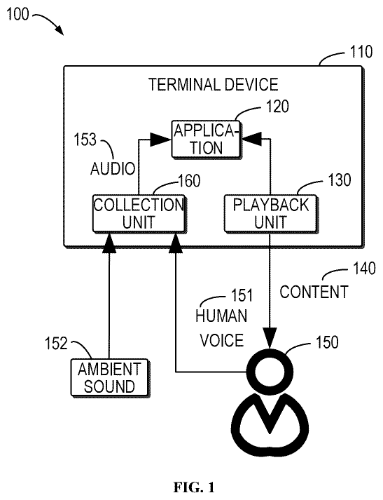

FIG. 1 illustrates a schematic diagram of an example environment 100 in which embodiments of the present disclosure can be implemented. Referring to FIG. 1, the example environment 100 may include a terminal device 110.

In the example environment 100, the terminal device 110 is provided with an application 120 for implementing an audio playback function. The application 120 may process various content including audio to be played, including, but not limited to, various videos, songs, or telephone speeches. As an example, the application 120 may process content that includes audio to be played and output the processed content 140 to the user 150 in the form of sound via a playback unit 130 of the terminal device 110. The playback unit 130 is, for example, a speaker.

In addition to the audio playback function, the terminal device 110 may further set a collection unit 160 configured to implement a sound collection function. The collection unit 160 may collect a human voice 151 of the user 150 and an ambient sound 152 around the terminal device 110. As an example, the collection unit 160 may include, but is not limited to, a microphone or a microphone array. The collection unit 160 may process the collected human voice 151 and the ambient sound 152 into an audio 153, and send the audio 153 to the application 120. The application 120 may automatically adjust the playback volume of the terminal device 110 based on the noise level of the audio 153, so that the user 150 may hear the content 140 clearly in different environments.

In some embodiments, the terminal device 110 may be a wearable device, including earphones, wearable speakers, glasses with built-in audio playback function, wristbands, or watches. Such terminal device 110 may output the content 140 to the user 150 via a built-in loudspeaker.

In some further embodiments, the terminal device 110 may also be any type of mobile, fixed, or portable terminal, including a mobile phone, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, e-book device, game device, or any combination of the foregoing, including accessories and peripherals of these devices or any combination thereof. In some embodiments, the terminal device 110 may also support any type of user interface (such as a “wearable” circuit). Such terminal device 110 can output the content 140 to the user 150 via a built-in loudspeaker, an external loudspeaker, or an external earphone.

It should be understood that the structures and functions of the various elements in the environment 100 are described solely for illustrative purposes and do not imply any limitation on the scope of the present disclosure.

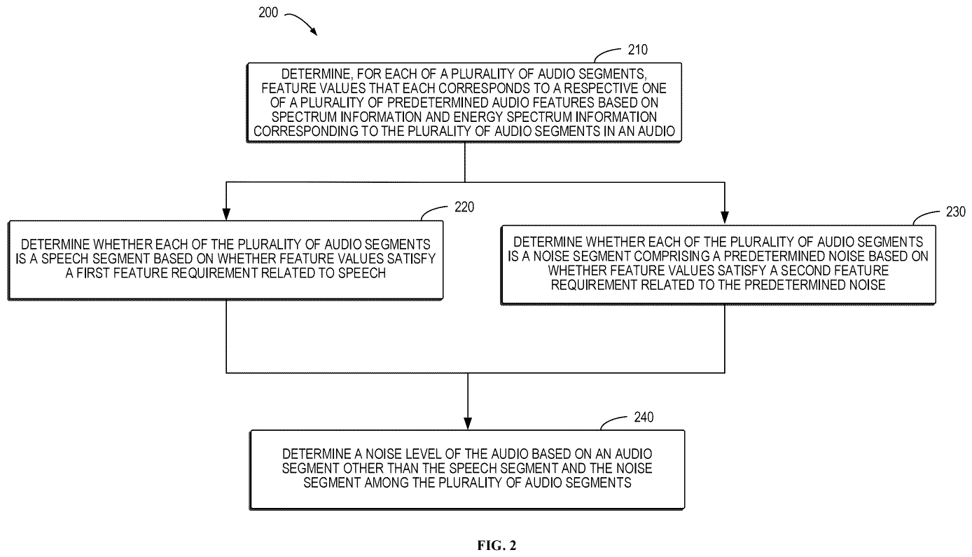

FIG. 2 illustrates a flowchart of an example process 200 of a method for determining a noise level according to some embodiments of the present disclosure. The process 200 may be implemented at the terminal device 110. The process 200 will be described below with reference to FIG. 1.

At block 210, the terminal device 110 determines, for each of a plurality of audio segments, feature values that each corresponds to a respective one of a plurality of predetermined audio features based on spectrum information and energy spectrum information corresponding to the plurality of audio segments in the audio 153.

In some embodiments, the audio 153 may be audio collected in association with the terminal device 110 itself for performing noise estimation. As an example, depending on the specific environment in which the device is located, the audio 153 may include the ambient sound 152 and the human voice 151. The ambient sound 152 includes, but is not limited to, wind noise, vehicle driving sounds, and other similar noises. The noise estimation result may be used for various purposes. As an example, the noise estimation result (i.e., the noise level around the device) may be used to adjust the playback volume of the device to suit the current environment. As another example, noise estimation may also indicate the environmental context in which the device is located, thereby assisting in determining the execution of other appropriate tasks.

The audio segment may refer to a short-duration piece of audio data extracted from the audio 153. The audio segments within the audio 153 may be of any length. In some embodiments, each audio segment may include one or more audio frames. In embodiments of the present disclosure, each audio segment may include a single audio frame. In this way, robust environmental noise detection at the single-frame level can be implemented, reducing computational complexity.

As an example, each audio segment may have corresponding spectrum information and energy spectrum information. The spectrum information may be frequency-domain representation of an audio segment. As an example, assuming N predetermined frequency points, the spectrum information of the audio segment may be expressed as X[i] (i=0, 1, 2, . . . , N−1), where N and i are positive integers and i is any one of the plurality of predetermined frequency points. The terminal device 110 may determine the spectrum information X[i] of the audio segment by a Fourier transform. As an example, the terminal device 110 may determine the spectrum information X[i] of the audio segment by a Fast Fourier Transform (FFT). Additionally, according to actual requirements, the terminal device 110 may also determine the spectrum information X[i] of the audio segment by other time-frequency analysis methods. The energy spectrum information P[i] may represent the energy in distribution of the audio segment at the respective frequency points. As an example, the terminal device 110 may square the amplitude (or the squared modulus) of each frequency component in the spectrum information and then divide by an appropriate normalization factor (such as the signal length) to determine the energy spectrum information.

At block 220, the terminal device 110 determines whether each of the plurality of audio segments is a speech segment based on whether feature values, for each audio segment, that each corresponds to a respective one of a plurality of predetermined audio features satisfy a first feature requirement related to speech. At block 230, the terminal device 110 determines whether each of the plurality of audio segments is a noise segment including a predetermined noise based on whether the feature values, for each audio segment, that each corresponds to a respective one of a plurality of predetermined audio features satisfy a second feature requirement related to the predetermined noise.

The predetermined audio feature may be a set of features predefined to recognize whether the audio segment is a speech segment or a noise segment including a predetermined noise. For example, the plurality of predetermined audio features may include, but are not limited to, features related to audio duration, audio energy, and the like. In embodiments of the present disclosure, the specific audio segment may refer to a speech segment or a noise segment including a predetermined noise. As an example, the speech segment may refer to an audio segment including the human voice 151, and the predetermined noise may be noise such as wind noise that has a relatively small impact on the auditory experience of the user 150.

In some embodiments, the plurality of predetermined audio features includes at least one first predetermined audio feature indicating at least one type of audio energy of an audio segment. The terminal device 110 may extract, for each of the plurality of audio segments, a feature value corresponding to the at least one first predetermined audio feature of the plurality of predetermined audio features based on the spectrum information X[i] and the energy spectrum information P[i].

As an example, for each audio segment, the terminal device 110 may determine, based on the corresponding spectrum information X[i] and energy spectrum information P[i], the energy value of each type of audio energy (such as speech energy or noise energy of the predetermined noise) of the audio segment at a plurality of frequency points. It should be noted that the number and size of the frequency points may be set as required, and embodiments of the present disclosure impose no limitation thereon. It can be understood that the greater the number of frequency points, the more conducive it is to analyze the characteristics of the audio segment in finer detail. The feature value corresponding to the first predetermined audio feature may be determined by the terminal device 110 through calculation based on the energy values of the corresponding type of audio energy at the plurality of frequency points. For each first predetermined audio feature, for instance, the terminal device 110 may determine the feature value of that first predetermined audio feature by calculating the sum of the energies, the average energy, or the energy within a specific frequency range of the corresponding type of audio energy at the plurality of frequency points. In this way, the terminal device 110 can separately quantify the various types of audio energy in the audio segment, which is conducive to enhancing understanding of characteristics of the audio segment by the terminal device 110.

In some embodiments, the at least one first predetermined audio feature includes, but is not limited to, harmonic energy of the audio segment, de-harmonic energy of the audio segment, first frequency band energy related to the speech in the audio segment, second frequency band energy related to the predetermined noise in the audio segment, high-frequency energy of the audio segment higher than a first frequency, and/or low-frequency energy of the audio segment lower than a second frequency. The second frequency is lower than or equal to the first frequency.

As an example, the harmonic energy may refer to energy located at the fundamental frequency of an audio segment and at integer multiples of the fundamental frequency (i.e., harmonic components); the corresponding feature value is the magnitude of the harmonic energy. The de-harmonic energy refers to the energy remaining in the audio segment after the harmonic components are removed; the corresponding feature value is the magnitude of the de-harmonic energy.

As an example, the first frequency band energy related to the speech may refer to the energy in the audio segment that is located in the first frequency range; the corresponding feature value is the magnitude of the first frequency band energy. The first frequency band energy may also be referred to as speech band energy. The first frequency range may, for example, be selected according to characteristics of human voice. The second frequency band energy may refers to the energy within a second frequency range in the audio segment; the corresponding feature value is the magnitude of the second frequency band. The predetermined noise may be wind noise, and the second frequency band energy may also be referred as wind-noise-band energy. The second frequency range may, for example, be selected according to characteristics of the predetermined noise.

As an example, the high-frequency energy may refer to the energy of the high-frequency signal higher than the first frequency in the audio segment, the corresponding feature value is the magnitude of the high-frequency energy. The low-frequency energy may refer to the energy of the low-frequency signal lower than the second frequency in the audio segment, the corresponding feature value is the magnitude of the low-frequency energy. The first frequency and the second frequency may be selected as required; embodiments of the present disclosure impose no limitation thereon.

When recognizing whether the audio segment is a speech segment or a noise segment including a predetermined noise, the foregoing various energies (i.e., harmonic energy, de-harmonic energy, first frequency band energy, second frequency band energy, high-frequency energy, and low-frequency energy) may be used separately, or may be used in combination, which is not limited in the embodiments of the present disclosure. In this way, the terminal device 110 may extract, from the audio segment, a feature that most reflects the difference between the speech segment and the noise segment including the predetermined noise and other audio segments, thereby helping to improve the recognition accuracy of the speech segment and the noise segment including the predetermined noise in subsequent steps.

In some embodiments, the harmonic energy of the audio segment is determined as follows. First, the terminal device 110 determines a plurality of harmonic components of the audio segment at a plurality of frequency points. The terminal device 110 then determines the harmonic energy of the audio segment based on energy of a set of harmonic components of the plurality of harmonic components. Energy of each harmonic component in the set of harmonic components is less than energy of a further harmonic component of the plurality of harmonic components other than the set of harmonic components.

As an example, the terminal device 110 may sort the plurality of harmonic components based on their respective energies. Then, the terminal device 110 may remove one or more harmonic components with higher energy from the sorted harmonic components, to obtain a set of harmonic components. Thereafter, the terminal device 110 determines the harmonic energy of the audio segment by summing the energies of the set of harmonic components. In this way, the terminal device 110 may exclude those harmonic components whose abnormally high energies may be caused by non-speech factors, so that the finally obtained harmonic energy more accurately reflects whether the audio segment is a speech segment.

As previously described, the energy spectrum information P[i] represents the energy distribution of the audio segment at a plurality of predetermined frequency points. The terminal device 110 may analyze the energy spectrum information P[i] to recognize frequency points corresponding to peak energies within the energy spectrum information P[i]. For clarity, these frequency points are hereinafter also referred to as peak frequency points. The terminal device 110 may then regard the signal of the audio segment at these peak frequency points as the harmonic component of the audio segment. Further, the terminal device 110 may determine the harmonic energy of the audio segment by summing the energies of the audio segment at these peak frequency points.

As an example, the process of determining the harmonic energy Pₕₐᵣ of each audio segment may be represented by formula (1):

$${P}_{har} = {\sum }_{i = h 1}^{n} Peak [ i ] \qquad ( 1 )$$

where n is the number of peak frequency points among the peak frequency points that participate in the calculation of harmonic energy Pₕₐᵣ, and Peak[i] represents the energy of the i-th peak frequency point, and h1 is the starting peak frequency point set as required among the peak frequency points (or, equivalently, the starting harmonic component in the set of harmonic components). As an example, the terminal device 110 may sort all peak frequency points in descending order according to the energy corresponding to each peak frequency point. When h1=1, the terminal device 110 takes the first peak frequency point after the sort as the starting peak frequency point. Then, the terminal device 110 selects, in order of decreasing energy, n peak frequency points and computes the sum of their energies, thereby obtaining the harmonic energy Pₕₐᵣ of the audio segment. When h1=2, the terminal device 110 takes the second peak frequency point after the sort as the starting peak frequency point. Then, the terminal device 110 selects n peak frequencies according to energy from high to low, and calculates a sum of energies of the n peak frequencies, to obtain harmonic energy Pₕₐᵣ of the audio segment, and so on.

In some embodiments, the first frequency band energy of the audio segment may be determined in the following manner. The terminal device 110 selects, from the plurality of frequency points and based on the first frequency range, one or more frequency points located within the first frequency range. Then, the terminal device 110 determines the first frequency band energy by calculating the sum of the energies of the frequency points located within the first frequency range.

As an example, the process of determining the first frequency band energy P_{speech} of the audio segment may be represented by formula (2):

$${P}_{speech} = {\sum }_{j = s 1}^{s 2} P [ j ] \qquad ( 2 )$$

where s1 is the frequency point corresponding to the lower limit of the first frequency range among the plurality of frequency points, s2 is the frequency point corresponding to the upper limit of the first frequency range, and P[j] represents the energy of the j-th frequency point. The upper and lower limits of the first frequency range may be determined according to actual characteristics of human voice; embodiments of the present disclosure impose no limitation thereon.

In some embodiments, the second frequency band energy of the audio segment may be determined in the following manner. The terminal device 110 selects, from the plurality of frequency points and based on the second frequency range, one or more frequency points located within the second frequency range. Then, the terminal device 110 determines the second frequency band energy by calculating the sum of the energies of the frequency points located within the second frequency range.

As an example, the process of determining the second frequency band energy P_{wind} of the audio segment may be represented by formula (3):

$${P}_{wind} = {\sum }_{j = w 1}^{w 2} P [ j ] \qquad ( 3 )$$

where w1 is the frequency point corresponding to the lower limit of the second frequency range among the plurality of frequency points, w2 is the frequency point corresponding to the upper limit of the second frequency range, and P[j] represents the energy of the j-th frequency point. The upper and lower limits of the second frequency range may be determined according to the actual characteristics of the predetermined noise; embodiments of the present disclosure impose no limitation thereon.

In some embodiments, the high-frequency energy of the audio segment may be determined in the following manner. The terminal device 110 selects, from the plurality of frequency points based on the first frequency, one or more frequency points higher than the first frequency. Then, the terminal device 110 determines the high-frequency energy of the audio segment by calculating the sum of the energies of the frequency points higher than the first frequency.

As an example, the process of determining the high-frequency energy P_{hf} of the audio segment may be represented by formula (4):

$${P}_{hf} = {\sum }_{j = k}^{N} P [ j ] \qquad ( 4 )$$

where k is the frequency point corresponding to the first frequency among the plurality of frequency points, N is the last frequency point among the plurality of frequency points, and P[j] presents the energy of the j-th frequency point.

In some embodiments, the low-frequency energy of an audio segment may be determined in the following manner. The terminal device 110 selects, from the plurality of frequency points and based on the second frequency, one or more frequency point lower than the second frequency. Then, the terminal device 110 determines the low-frequency energy of the audio segment by calculating the sum of the energies of the frequency points lower than the second frequency.

As an example, the process of determining the low-frequency energy P_{lf} of the audio segment may be represented by formula (5):

$${P}_{lf} = {\sum }_{j = 0}^{f} P [ j ] \qquad ( 5 )$$

where f is the frequency point corresponding to the second frequency among the plurality of frequency points, and P[j] represents the energy of the jth frequency point.

In some embodiments, the plurality of predetermined audio features includes at least one second predetermined audio feature, and the second predetermined audio feature indicates a flatness of energy of the audio segment at a plurality of frequency points, also referred to as a speech-band spectral flatness. Alternatively, or in addition, the plurality of predetermined audio features includes at least one third predetermined audio feature, each of the at least one third predetermined audio feature indicates a ratio of two different types of audio energy of the audio segment. In embodiments of the present disclosure, for each of the plurality of audio segments, the terminal device 110 may determine, based on the spectrum information X[i] and the energy spectrum information P[i] corresponding to the audio segment, the feature value corresponding to the second audio feature among the plurality of predetermined audio features in the audio segment. Alternatively, or in addition, the terminal device 110 may further determine, based on the spectrum information X[i] and the energy spectrum information P[i] corresponding to the audio segment, a feature value corresponding to at least one third predetermined audio feature among the plurality of predetermined audio features in the audio segment.

As an example, a flatness of energy of the audio segment at the plurality of frequency points may be used to indicate the uniformity with which the energy is distributed over the plurality of frequency points, and such flatness reflects how the energy of the audio segment varies across the different frequency points. The flatness of the energy may help the terminal device 110 distinguishing between different types of audio signals. For example, speech signals usually exhibit pronounced energy peaks at certain frequency points, whereas noise signals tend to have a more uniform energy distribution across a plurality of frequency points. As an example, the second predetermined audio feature may indicate the flatness of the first frequency band energy, and the higher the flatness of the first frequency band energy P_{speech}; the higher the flatness of P_{speech}, the more likely the audio segment is to be determined as a non-speech segment, whereas the lower the flatness of P_{speech}, the more likely the audio segment is to be determined as a speech segment.

As an example, the third predetermined audio feature indicates a ratio of two different types of audio energy of the audio segment. These different types of audio energy may be any of the previously described harmonic energy Pₕₐᵣ, the first frequency band energy P_{speech}, the second frequency band energy P_{wind}, the high-frequency energy P_{hf}, the low-frequency energy P_{tf}, or any other two energy types defined according to audio-processing requirements.

In some embodiments, the terminal device 110 may determine the flatness of the energy of the audio segment at the plurality of frequency points by any suitable flatness-calculation method (e.g., computing variance, standard deviation, etc.). As an example, the terminal device 110 may determine the flatness of the energy of the audio segment at the plurality of frequency points using the flatness calculation method shown in formula (6):

$$\frac{exp f ( \sum log ( P [ j ] ) )}{\sum ( P [ j ] )} \qquad ( 6 )$$

where exp f(Σ log(P[j])) denotes taking the exponential of the summed result of f(Σ log(P[j])), and f(Σ log(P[j])) applies a predetermined function f to the summed result of Σ log(P[j]); the function f may be used to further adjust or transform the summed result of Σ log(P[j]) to better suit the calculation requirements of audio flatness.

In this way, embodiments of the present disclosure may further determine the second predetermined audio feature and the third predetermined audio feature on the basis of the first predetermined audio feature. Further, the terminal device 110 may more accurately recognize whether the audio segment is a speech segment or a noise segment including a predetermined noise in combination with the three features.

In some embodiments, the at least one third predetermined audio feature includes a ratio of a sub-harmonic energy to a noise energy of the audio segment. The ratio of the sub-harmonic energy to the noise energy is determined based on harmonic energy and de-harmonic energy of the audio segment. Alternatively, or in addition, the at least one third predetermined audio feature further includes a ratio of the first frequency band energy P_{speech} to the second frequency band energy P_{wind} of the audio segment. The first frequency band energy P_{speech} is frequency band energy related to speech in the audio segment, and the second frequency band energy P_{wind} is frequency band energy related to the predetermined noise in the audio segment. Alternatively, or in addition, the ratio of the high-frequency energy P_{hf} to the low-frequency energy P_{lf} of the audio segment, where the high-frequency energy P_{hf} is energy higher than the first frequency, the low-frequency energy P_{lf} is energy lower than the second frequency, and the second frequency is lower than or equal to the first frequency.

As an example, the ratio of the sub-harmonic energy to the noise energy facilitates recognizing whether the audio segment is a speech segment. For example, a higher ratio indicates that the audio segment includes more harmonic components and fewer noise components, so the audio segment is more likely to be determined as a speech segment. A lower ratio indicates that the audio segment includes fewer harmonic components and more noise components, so the audio segment is more likely to be determined as a non-speech segment. It should be noted that the noise energy here may include, but is not limited to, the noise energy of the predetermined noise.

As an example, the ratio of the first frequency band energy P_{speech} to the second frequency band energy P_{wind} may also be referred to as the ratio of speech band energy to wind noise band energy. This ratio helps distinguishing whether an audio segment is a speech segment or a noise segment including a predetermined noise. For instance, a higher ratio indicates that the audio segment includes more speech components and fewer predetermined noise components, so the audio segment is more likely to be determined as a speech segment. A lower ratio indicates that the audio segment includes fewer speech components and more predetermined noise components, so the audio segment is more likely to be determined as a noise segment including the predetermined noise.

As an example, a ratio of high-frequency energy P_{hf} to low-frequency energy P_{lf} helps to distinguishing whether an audio segment is a noise segment including a predetermined noise. For example, the predetermined noise may include, but is not limited to, wind noise, a higher ratio indicates that the audio segment contains more high-frequency components and fewer low-frequency components, so the audio segment is more likely to be determined as a noise segment containing wind noise. A lower ratio indicates that the audio segment contains fewer high-frequency components and more low-frequency components, so the audio segment is more likely to be determined as an audio segment not containing wind noise.

As described above, the terminal device 110 can determine whether each of the plurality of audio segments is a speech segment based on whether feature values satisfy a first feature requirement related to speech.

As an example, the feature values herein may include the various energies, flatness values, and ratios between different energies described above. As an example, the terminal device 110 may select, from these energies, flatness values, and ratios between different energies, the feature values used for speech recognition, and then compare the selected feature values with the predetermined first feature requirement. For instance, if the feature values of an audio segment satisfy all or some of the conditions in the first feature requirement, the terminal device 110 determines that the audio segment is a speech segment; otherwise, the terminal device 110 determines that the audio segment is a non-speech segment.

In some embodiments, the first predetermined requirement indicates at least one of the following: a feature value corresponding to a flatness of the energy being less than a threshold flatness, a feature value corresponding to the ratio of the sub-harmonic energy to the noise energy being greater than a first threshold ratio, a feature value corresponding to the ratio of the first frequency band energy P_{speech} and the second frequency band energy P_{wind} being less than a second threshold ratio, and/or the first frequency band energy P_{speech} being greater than a first threshold energy. It should be understood that each of the thresholds mentioned herein and hereinafter may be specifically configured according to actual application scenarios, and the specific values of the thresholds are not limited in the embodiments of the present disclosure.

The flatness of the energy may indicate a degree of uniformity with which the energy of an audio segment is distributed across different frequency points. Since the speech signal usually has an uneven energy distribution, if the feature value corresponding to the energy flatness of an audio segment (for example, the specific flatness value) is low, for instance, lower the threshold flatness, the terminal device 110 may deem that the audio segment may include speech.

The ratio of the sub-harmonic energy to the noise energy may indicate a relative intensity of the harmonic strength of harmonic components versus noise components in the audio signal. Because speech signals usually possess strong harmonic components, if the feature value corresponding to a ratio of the sub-harmonic energy to the noise energy is larger, for example, larger than the predetermined first threshold ratio, the terminal device 110 may consider that the audio segment may include speech.

The ratio of the first frequency band energy to the second frequency band energy may indicate a relative magnitude of the speech-band energy versus the predetermined noise-band energy in the audio signal. If the feature value corresponding to the ratio of the first frequency band energy to the second frequency band energy is relatively low, for example, lower than the second threshold value, it indicates that the speech component of the audio segment is more, and therefore, the terminal device 110 may consider that the audio segment may include speech.

The first frequency band energy P_{speech} may indicate a magnitude of the speech-related band energy within the audio segment. Because speech signals generally exhibit a high energy level in this band, if the first frequency band energy P_{speech} is higher than the first threshold energy, the terminal device 110 may consider that the audio segment may include speech.

As an example, the terminal device 110 may determine that the audio segment is a speech segment including speech if the above requirements are all satisfied.

As described above, the terminal device 110 may determine whether each of the plurality of audio segments is a noise segment including a predetermined noise based on whether feature values satisfy a second feature requirement related to the predetermined noise.

As an example, the feature values herein may include the various energies, flatness values, and ratios between different energies described above. As an example, the terminal device 110 may select, from these energies, flatness values, and ratios between different energies, the feature values used for recognizing a predetermined noise, and then compare the selected feature values with the predetermined second feature requirement. For instance, if the feature values of an audio segment satisfy all or part of the conditions in the second feature requirement, the terminal device 110 determines that the audio segment is a noise segment including the predetermined noise. Otherwise, the terminal device 110 determines that the audio segment is an audio segment not including the predetermined noise.

In some embodiments, the second predetermined requirement indicates at least one of the following: a feature value corresponding to the ratio of the first frequency band energy P_{speech} and the second frequency band energy P_{wind} being greater than a third threshold ratio, a feature value corresponding to the ratio of the high-frequency energy P_{hf} to the low-frequency energy P_{lf} of the audio segment being less than a fourth threshold ratio, and/or the second frequency band energy P_{wind} being greater than the second threshold energy.

As previously described, the ratio of the first frequency band energy P_{speech} to the second frequency band energy P_{wind} may indicate a relative magnitude of the speech-band energy to the predetermined noise-band energy in the audio signal. If the feature value corresponding to the ratio of the first frequency band energy P_{speech} to the second frequency band energy P_{wind} (for example, the specific ratio) is greater than the third threshold value, it means that the audio segment includes more predetermined noise component. Therefore, the terminal device 110 may consider that the audio segment may include the predetermined noise.

The ratio of the high-frequency energy P_{hf} to the low-frequency energy P_{lf} may indicate the relative magnitude of high-frequency components to low-frequency components in the audio segment. If the feature value corresponding to the ratio of the high-frequency energy P_{hf} to the low-frequency energy P_{lf} (for example, the specific ratio) is less than the fourth threshold ratio, it means that the low-frequency components in the audio segment have relatively higher energy and the high-frequency components have relatively lower energy. In this case, when the predetermined noise is a low-frequency noise, the terminal device 110 may consider that the audio segment may include the predetermined noise.

The second frequency band energy P_{wind} may indicate the magnitude of the band energy related to the predetermined noise within the audio segment. Because the predetermined noise signal usually exhibits a high energy level in this band, if the second-band energy P_{wind} is greater than the second threshold energy, the terminal device 110 may consider that the audio segment may include the predetermined noise.

As an example, the terminal device 110 may determine that the audio segment is a noise segment including the predetermined noise when the above requirements are all satisfied.

At block 240, the terminal device 110 determines a noise level of the audio 153 based on an audio segment other than the speech segment and the noise segment among the plurality of audio segments.

As previously described, the terminal device 110 may recognize whether each audio segment is a speech segment or a noise segment including a predetermined noise. The terminal device 110 filters, from the plurality of audio segments, those audio segments that have been determined neither as speech segments nor as noise segments including a predetermined noise. These segments may include other background noise, such as vehicle driving sounds.

For the filtered audio segments, the terminal device 110 may determine the noise level of the audio by means such as loudness calculation or Root Mean Square (RMS) calculation.

In some embodiments, the terminal device 110 may store a corresponding audio segment into a queue in response to the corresponding audio segment among the plurality of audio segments being determined to be an audio segment other than the speech segment and the noise segment. The terminal device 110 then extracts a set of audio segments falling within a predetermined period of the audio 153 from audio segments stored in the queue. In turn, the terminal device 110 determines a noise level of the audio 153 within the predetermined period based at least on a noise estimation for the set of audio segments.

As an example, once the terminal device 110 recognizes an audio segment that is neither a speech segment nor a noise segment including predetermined noise, it stores the audio segment into the queue. Next, the terminal device 110 may, based on a predetermined time interval T1, extract one or more audio segments that have not yet undergone noise estimation from the queue, such audio segments thus being a set of audio segments falling within the predetermined period of the audio 153. The terminal device 110 may determine the noise level of the audio within the predetermined period by performing, on this set of audio segments, operations such as loudness calculation or RMS calculation. This noise level may be determined based on the average intensity of the set of audio segments.

In this way, the noise level of the audio 153 within the predetermined period is determined based on a set of audio segments. When each audio segment contains only one or a small number of audio frames, this approach helps reducing jitter in the noise level, thereby achieving smooth processing of noise estimation.

In some embodiments, the terminal device 110 may sort the set of audio segments based on respective energy magnitudes of respective audio segments among the set of audio segments to obtain an audio segment sequence. Then, the terminal device 110 determines a noise level of the audio 153 within the predetermined period based on a noise estimation of an audio segment at a predetermined location among the audio segment sequence.

As an example, the predetermined location may be any location in the audio segment sequence. It may be determined by a predetermined percentage, an absolute location, or another criterion. As an example, the predetermined location may be the audio segment remaining after excluding the first % X and last % Y audio segments in the audio segment sequence. X and Y may be any real numbers and may be adjusted according to actual needs.

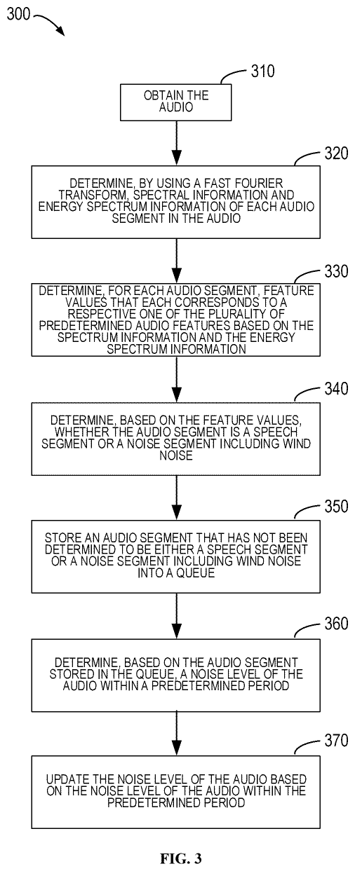

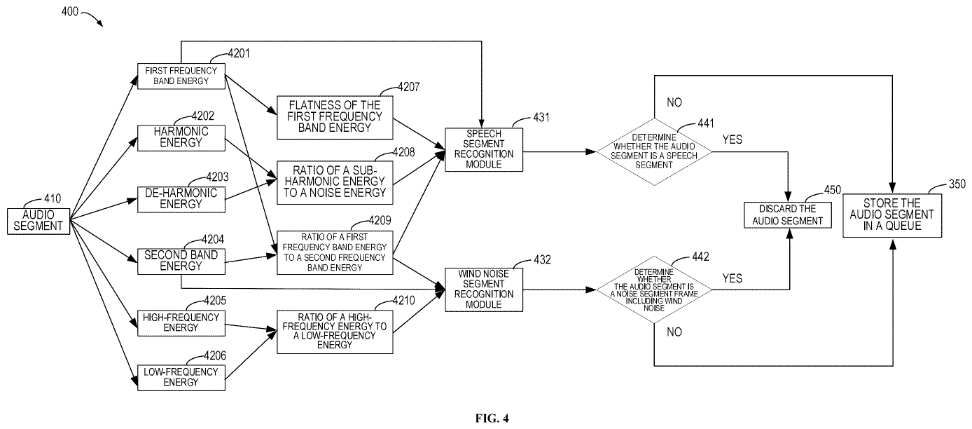

FIG. 3 illustrates a flowchart of an overall process 300 for determining a noise level according to some embodiments of the present disclosure, and FIG. 4 illustrates a flowchart of a process 400 for recognizing a speech segment and a noise segment according to some embodiments of the present disclosure. Further details of embodiments of the present disclosure are described below with reference to FIG. 1, FIG. 3, and FIG. 4 by using an example in which the predetermined noise is wind noise.

At block 310, the terminal device 110 obtains the audio 153. As an example, the audio 153 may include the human voice 151 and the ambient sound 152.

At block 320, the terminal device 110 determines, by using a Fast Fourier transform, spectrum information and energy spectrum information of each audio segment 410 in the audio 153.

At block 330, the terminal device 110 determines, based on the spectrum information and the energy spectrum, feature values that each corresponds to a respective one of a plurality of predetermined audio features 410.

As an example, the plurality of predetermined audio features may include a first frequency band energy 4201, harmonic energy 4202, de-harmonic energy 4203, second frequency band energy 4204, high-frequency energy 4205, and low-frequency energy 4206. Further, the plurality of predetermined audio features may further include a flatness of the first frequency band energy 4207, a ratio of a sub-harmonic energy to a noise energy 4208, a ratio of a first frequency band energy to a second frequency band energy 4209, and a ratio of a high-frequency energy to a low-frequency energy 4210.

At block 340, the terminal device 110 determines, based on the feature values, whether the audio segment 410 is a speech segment or a noise segment including wind noise.

As an example, the terminal device 110 provides the first frequency band energy 4201, the flatness of the first frequency band energy 4207, the ratio of the sub-harmonic energy to the noise energy 4208, and the ratio of the first frequency band energy to the second frequency band energy 4209 to a speech segment recognition module 431. At block 441, the speech segment recognition module 431 determines whether the audio segment 410 is a speech segment based on whether the first frequency band energy 4201, the flatness of the first frequency band energy 4207, the ratio of the sub-harmonic energy to the noise energy 4208, and the ratio of the first frequency band energy to the second frequency band energy 4209 provided to the speech segment recognition module 431 satisfy a first feature requirement.

As an example, the terminal device 110 provides the second frequency band energy 4204, the ratio of the sub-harmonic energy to the noise energy 4208, and the ratio of the first frequency band energy to the second frequency band energy 4209 to a wind noise segment recognition module 432. At block 442, the wind noise segment recognition module 432 determines whether the audio segment 410 is a noise segment including wind noise based on whether the second frequency band energy 4204, the ratio of the sub-harmonic energy to the noise energy 4208, and the ratio of the first frequency band energy to the second frequency band energy 4209 provided to the wind noise segment recognition module 432 satisfy a second feature requirement.

If the audio segment 410 is determined to be a speech segment or a noise segment including wind noise, the terminal device 110 would discard the audio segment 410 at block 450. If the audio segment 410 is neither determined as speech nor as a noise segment including wind noise, then at block 350, the terminal device 110 stores the audio segment 410 in a queue.

At block 360, a noise level of the audio within a predetermined period is determined based on the audio segment stored in the queue.

At block 370, the noise level of the audio is updated based on the noise level of the audio within the predetermined period.

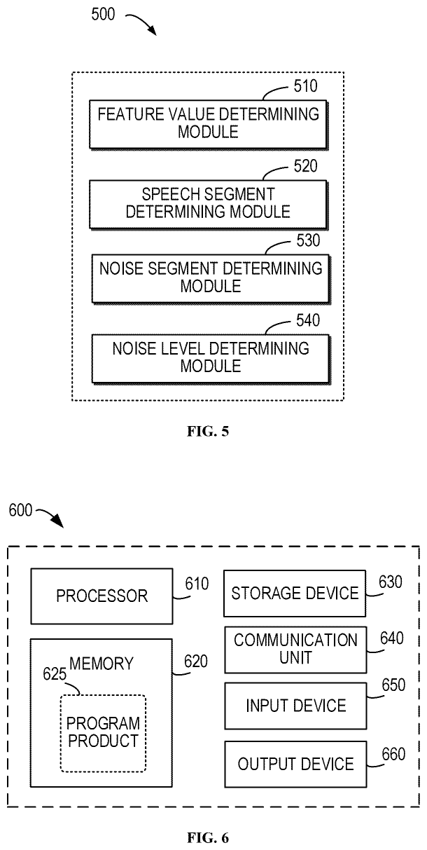

Embodiments of the present disclosure also provide a corresponding apparatus for implementing the above method or process. FIG. 5 illustrates a schematic structural block diagram of an apparatus 500 for determining a noise level according to some embodiments of the present disclosure. The apparatus 500 may be implemented or included in the terminal device 110. The various modules/components in the apparatus 500 may be implemented by hardware, software, firmware, or any combination thereof.

Referring to FIG. 5, the apparatus 500 includes a feature value determining module 510, a speech segment determining module 520, a noise segment determining module 530, and a noise level determining module 540. The feature value determining module 510 is configured to determine, for each of a plurality of audio segments, feature values that each corresponds to a respective one of a plurality of predetermined audio features based on spectrum information and energy spectrum information corresponding to the plurality of audio segments in an audio. The speech segment determining module 520 is configured to determine whether each of the plurality of audio segments is a speech segment based on whether the feature values satisfy a first feature requirement related to speech. The noise segment determining module 530 is configured to determine whether each of the plurality of audio segments is a noise segment including a predetermined noise based on whether feature values satisfy a second feature requirement related to the predetermined noise. The noise level determining module 540 is configured to determine a noise level of the audio based on an audio segment other than the speech segment and the noise segment among the plurality of audio segments.

In some embodiments, the feature value determining module 510 is further configured to extract, from each of the plurality of audio segments and based on the spectrum information and the energy spectrum information, a feature value corresponding to at least one first predetermined audio feature of the plurality of predetermined audio features, where the at least one first predetermined audio feature indicates at least one type of audio energy of the audio segment.

In some embodiments, the at least one first predetermined audio feature includes at least one of the following: harmonic energy of the audio segment, de-harmonic energy of the audio segment, first frequency band energy related to the speech in the audio segment, second frequency band energy related to the predetermined noise in the audio segment, high-frequency energy of the audio segment higher than a first frequency, or low-frequency energy of the audio segment lower than a second frequency, where the second frequency is lower than or equal to the first frequency.

In some embodiments, the harmonic energy of the audio segment is determined by: determining a plurality of harmonic components of the audio segment at a plurality of frequency points; and determining the harmonic energy of the audio segment based on energy of a set of harmonic components of the plurality of harmonic components, where energy of each harmonic component in the set of harmonic components is less than energy of a further harmonic component of the plurality of harmonic components other than the set of harmonic components

In some embodiments, the feature value determining module 510 is further configured to: for each of the plurality of audio segments, determine, based on the spectrum information and the energy spectrum information corresponding to the audio segment, a feature value corresponding to a second audio feature among the plurality of predetermined audio features in the audio segment, where the second predetermined audio feature indicates a flatness of energy of the audio segment at a plurality of frequency points, or determine, based on the spectrum information and the energy spectrum information corresponding to the audio segment, a feature value corresponding to at least one third predetermined audio feature among the plurality of predetermined audio features in the audio segment, where each of the at least one third predetermined audio feature indicates a ratio of two different types of audio energy of the audio segment.

In some embodiments, the at least one third predetermined audio feature includes at least one of the following: a ratio of a sub-harmonic energy to a noise energy of the audio segment, where the ratio of sub-harmonic energy to noise energy of the audio segment is determined based on harmonic energy and de-harmonic energy of the audio segment; a ratio of a first frequency band energy to a second frequency band energy of the audio segment, where the first frequency band energy is a frequency band energy related to the speech in the audio segment, and the second frequency band energy is a frequency band energy related to the predetermined noise in the audio segment; or a ratio of a high-frequency energy to a low-frequency energy of the audio segment, where the high-frequency energy is energy higher than the first frequency, the low-frequency energy is energy lower than the second frequency, and the second frequency is lower than or equal to the first frequency.

In some embodiments, the first predetermined requirement indicates at least one of the following: a feature value corresponding to a flatness of the energy being less than a threshold flatness, a feature value corresponding to the ratio of the sub-harmonic energy to the noise energy being greater than a first threshold ratio, a feature value corresponding to the ratio of the first frequency band energy to the second frequency band energy being less than a second threshold ratio, or the first frequency band energy being greater than a first threshold energy.

In some embodiments, the second predetermined requirement indicates at least one of the following: a feature value corresponding to the ratio of the first frequency band energy to the second frequency band energy being greater than a third threshold ratio, a feature value corresponding to the ratio of the high-frequency energy to the low-frequency energy of the audio segment being less than a fourth threshold ratio, or the second frequency band energy being greater than the second threshold energy.

In some embodiments, the noise level determining module 540 is further configured to: store a corresponding audio segment into a queue in response to the corresponding audio segment among the plurality of audio segments being determined to be an audio segment other than the speech segment and the noise segment; extract a set of audio segments falling within a predetermined period of the audio from audio segments stored in the queue; and determine a noise level of the audio within the predetermined period based at least on a noise estimation for the set of audio segments.

In some embodiments, the noise level determining module 540 is further configured to: sort the set of audio segments based on respective energy magnitudes of respective audio segments among the set of audio segments to obtain an audio segment sequence; and determine a noise level of the audio within the predetermined period based on a noise estimation of an audio segment at a predetermined location among the audio segment sequence.

In some embodiments, each of the plurality of audio segments includes an audio frame.

FIG. 6 illustrates a block diagram of an electronic device 600 in which one or more embodiments of the present disclosure may be implemented. For example, the electronic device 600 may be configured to implement the terminal device 110 shown in FIG. 1 or the apparatus 500 shown in FIG. 5. It should be understood that the electronic device 600 illustrated in FIG. 6 is merely example and should not constitute any limitation on the functionality and scope of the embodiments described herein.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processor 610 may be an actual or virtual processor and capable of performing various processes according to programs stored in the memory 620. In multiprocessor systems, multiple processors execute computer-executable instructions in parallel to improve parallel processing capabilities of the electronic device 600.

The electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, magnetic disk, or any other medium, which may be capable of storing information and/or data and may be accessed within the electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, a computer-readable storage medium having computer-executable instructions stored thereon is provided, where the computer program is executable by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for determining a noise level, comprising:
determining, for each of a plurality of audio segments, feature values that each corresponds to a respective one of a plurality of predetermined audio features based on spectrum information and energy spectrum information corresponding to the plurality of audio segments in an audio;
determining whether each of the plurality of audio segments is a speech segment based on whether feature values satisfy a first feature requirement related to speech;
determining whether each of the plurality of audio segments is a noise segment comprising a predetermined noise based on whether feature values satisfy a second feature requirement related to the predetermined noise; and
determining a noise level of the audio based on an audio segment other than the speech segment and the noise segment among the plurality of audio segments.

2. The method of claim 1, wherein determining, for each audio segment, feature values that each corresponds to a respective one of a plurality of predetermined audio features comprises:
extracting, from each of the plurality of audio segments and based on the spectrum information and the energy spectrum information, a feature value corresponding to at least one first predetermined audio feature of the plurality of predetermined audio features, wherein the at least one first predetermined audio feature indicates at least one type of audio energy of the audio segment.

3. The method of claim 2, wherein the at least one first predetermined audio feature comprises at least one of the following:
harmonic energy of the audio segment,
de-harmonic energy of the audio segment,
first frequency band energy related to the speech in the audio segment,
second frequency band energy related to the predetermined noise in the audio segment,
high-frequency energy of the audio segment higher than a first frequency, or
low-frequency energy of the audio segment lower than a second frequency, wherein the second frequency is lower than or equal to the first frequency.

4. The method of claim 3, wherein the harmonic energy of the audio segment is determined by:
determining a plurality of harmonic components of the audio segment at a plurality of frequency points; and
determining the harmonic energy of the audio segment based on energy of a set of harmonic components of the plurality of harmonic components, wherein energy of each harmonic component in the set of harmonic components is less than energy of a further harmonic component of the plurality of harmonic components other than the set of harmonic components.

5. The method of claim 1, wherein determining the feature values each corresponding to the plurality of predetermined audio features comprises at least one of the following: for each of the plurality of audio segments,
determining, based on the spectrum information and the energy spectrum information corresponding to the audio segment, a feature value corresponding to a second audio feature among the plurality of predetermined audio features in the audio segment, wherein the second predetermined audio feature indicates a flatness of energy of the audio segment at a plurality of frequency points, or
determining, based on the spectrum information and the energy spectrum information corresponding to the audio segment, a feature value corresponding to at least one third predetermined audio feature among the plurality of predetermined audio features in the audio segment, wherein each of the at least one third predetermined audio feature indicates a ratio of two different types of audio energy of the audio segment.

6. The method of claim 5, wherein the at least one third predetermined audio feature comprises at least one of the following:
a ratio of a sub-harmonic energy to a noise energy of the audio segment, wherein the ratio of sub-harmonic energy to noise energy of the audio segment is determined based on harmonic energy and de-harmonic energy of the audio segment;
a ratio of a first frequency band energy to a second frequency band energy of the audio segment, wherein the first frequency band energy is a frequency band energy related to the speech in the audio segment, and the second frequency band energy is a frequency band energy related to the predetermined noise in the audio segment; or
a ratio of a high-frequency energy to a low-frequency energy of the audio segment, wherein the high-frequency energy is energy higher than the first frequency, the low-frequency energy is energy lower than the second frequency, and the second frequency is lower than or equal to the first frequency.

7. The method of claim 6, wherein the first predetermined requirement indicates at least one of the following:
a feature value corresponding to a flatness of the energy being less than a threshold flatness,
a feature value corresponding to the ratio of the sub-harmonic energy to the noise energy being greater than a first threshold ratio,
a feature value corresponding to the ratio of the first frequency band energy to the second frequency band energy being less than a second threshold ratio, or
the first frequency band energy being greater than a first threshold energy.

8. The method of claim 6, wherein the second predetermined requirement indicates at least one of the following:
a feature value corresponding to the ratio of the first frequency band energy to the second frequency band energy being greater than a third threshold ratio,
a feature value corresponding to the ratio of the high-frequency energy to the low-frequency energy of the audio segment being less than a fourth threshold ratio, or
the second frequency band energy being greater than the second threshold energy.

9. The method of claim 1, wherein determining the noise level of the audio based on an audio segment other than the speech segment and the noise segment among the plurality of audio segments comprises:
storing a corresponding audio segment into a queue in response to the corresponding audio segment among the plurality of audio segments being determined to be an audio segment other than the speech segment and the noise segment;
extracting a set of audio segments falling within a predetermined period of the audio from audio segments stored in the queue; and
determining a noise level of the audio within the predetermined period based at least on a noise estimation for the set of audio segments.

10. The method of claim 9, wherein determining the noise level of the audio within the predetermined period based at least on the noise estimation for the set of audio segments comprises:
sorting the set of audio segments based on respective energy magnitudes of respective audio segments among the set of audio segments to obtain an audio segment sequence; and
determining a noise level of the audio within the predetermined period based on a noise estimation of an audio segment at a predetermined location among the audio segment sequence.

11. The method of claim 1, wherein each of the plurality of audio segments comprises an audio frame.

12. An electronic device, comprising:
at least one processor; and
at least one memory coupled to the at least one processor and storing instructions for execution by the at least one processor, the instructions, when executed by the at least one processor, causing the electronic device to perform operations comprising:
determining, for each of a plurality of audio segments, feature values that each corresponds to a respective one of a plurality of predetermined audio features based on spectrum information and energy spectrum information corresponding to the plurality of audio segments in an audio;
determining whether each of the plurality of audio segments is a speech segment based on whether feature values satisfy a first feature requirement related to speech;
determining whether each of the plurality of audio segments is a noise segment comprising a predetermined noise based on whether feature values satisfy a second feature requirement related to the predetermined noise; and
determining a noise level of the audio based on an audio segment other than the speech segment and the noise segment among the plurality of audio segments.

13. The electronic device of claim 12, wherein determining, for each audio segment, feature values that each corresponds to a respective one of a plurality of predetermined audio features comprises:
extracting, from each of the plurality of audio segments and based on the spectrum information and the energy spectrum information, a feature value corresponding to at least one first predetermined audio feature of the plurality of predetermined audio features, wherein the at least one first predetermined audio feature indicates at least one type of audio energy of the audio segment.

14. The electronic device of claim 13, wherein the at least one first predetermined audio feature comprises at least one of the following:
harmonic energy of the audio segment,
de-harmonic energy of the audio segment,
first frequency band energy related to the speech in the audio segment,
second frequency band energy related to the predetermined noise in the audio segment,
high-frequency energy of the audio segment higher than a first frequency, or
low-frequency energy of the audio segment lower than a second frequency, wherein the second frequency is lower than or equal to the first frequency.

15. The electronic device of claim 14, wherein the harmonic energy of the audio segment is determined by:
determining a plurality of harmonic components of the audio segment at a plurality of frequency points; and
determining the harmonic energy of the audio segment based on energy of a set of harmonic components of the plurality of harmonic components, wherein energy of each harmonic component in the set of harmonic components is less than energy of a further harmonic component of the plurality of harmonic components other than the set of harmonic components.

16. The electronic device of claim 12, wherein determining the feature values each corresponding to the plurality of predetermined audio features comprises at least one of the following: for each of the plurality of audio segments,
determining, based on the spectrum information and the energy spectrum information corresponding to the audio segment, a feature value corresponding to a second audio feature among the plurality of predetermined audio features in the audio segment, wherein the second predetermined audio feature indicates a flatness of energy of the audio segment at a plurality of frequency points, or
determining, based on the spectrum information and the energy spectrum information corresponding to the audio segment, a feature value corresponding to at least one third predetermined audio feature among the plurality of predetermined audio features in the audio segment, wherein each of the at least one third predetermined audio feature indicates a ratio of two different types of audio energy of the audio segment.

17. The electronic device of claim 16, wherein the at least one third predetermined audio feature comprises at least one of the following:
a ratio of a sub-harmonic energy to a noise energy of the audio segment, wherein the ratio of sub-harmonic energy to noise energy of the audio segment is determined based on harmonic energy and de-harmonic energy of the audio segment;
a ratio of a first frequency band energy to a second frequency band energy of the audio segment, wherein the first frequency band energy is a frequency band energy related to the speech in the audio segment, and the second frequency band energy is a frequency band energy related to the predetermined noise in the audio segment; or
a ratio of a high-frequency energy to a low-frequency energy of the audio segment, wherein the high-frequency energy is energy higher than the first frequency, the low-frequency energy is energy lower than the second frequency, and the second frequency is lower than or equal to the first frequency.

18. The electronic device of claim 17, wherein the first predetermined requirement indicates at least one of the following:
a feature value corresponding to a flatness of the energy being less than a threshold flatness,
a feature value corresponding to the ratio of the sub-harmonic energy to the noise energy being greater than a first threshold ratio,
a feature value corresponding to the ratio of the first frequency band energy to the second frequency band energy being less than a second threshold ratio, or
the first frequency band energy being greater than a first threshold energy.

19. The electronic device of claim 17, wherein the second predetermined requirement indicates at least one of the following:
a feature value corresponding to the ratio of the first frequency band energy to the second frequency band energy being greater than a third threshold ratio,
a feature value corresponding to the ratio of the high-frequency energy to the low-frequency energy of the audio segment being less than a fourth threshold ratio, or
the second frequency band energy being greater than the second threshold energy.

20. A non-transitory computer-readable storage medium having computer-executable instructions stored thereon, the computer-executable instructions being executable by a processor to implement operations comprising:
determining, for each of a plurality of audio segments, feature values that each corresponds to a respective one of a plurality of predetermined audio features based on spectrum information and energy spectrum information corresponding to the plurality of audio segments in an audio;
determining whether each of the plurality of audio segments is a speech segment based on whether feature values satisfy a first feature requirement related to speech;
determining whether each of the plurality of audio segments is a noise segment comprising a predetermined noise based on whether feature values satisfy a second feature requirement related to the predetermined noise; and
determining a noise level of the audio based on an audio segment other than the speech segment and the noise segment among the plurality of audio segments.
